(19) United States
(12) Patent Application Publication
(10) Pub. No.: US 2016/0291846 A1
(43) Pub. Date: Oct. 6, 2016

(54) GENERATING CAROUSEL USER INTERFACE WITH GRAPHICS PROCESSING UNIT

(71) Applicant: AirWatch LLC, Atlanta, GA (US)

(72) Inventors: William DeWeese, Haltom City, TX (US); Kevin Marshall McKeithan, II, Fort Worth, TX (US)

(21) Appl. No.: 14/674,313

(22) Filed: Mar. 31, 2015

(51) Int. Cl. G06F 3/0484; G06F 3/0488; G06F 3/0486; G06T 1/20; G06F 3/0481; G06F 3/0482; G06F 3/0485; G06F 17/21; G06F 3/0483; G06T 15/00

(52) U.S. Cl. CPC G06F 3/04845; G06F 3/0483; G06F 3/04883; G06F 3/0486; G06T 15/00; G06F 3/04817; G06F 3/0482; G06F 3/0485; G06F 17/212; G06F 3/04815; G06T 1/20; G06F 2203/04803; G06F 2203/04802

(57) ABSTRACT

Disclosed are various embodiments for generating a carousel user interface in which screenshots are shown. The files can include, for example, recently accessed files that are accessed on a client device. Screenshots for recently accessed files can be captured. The screenshots can be incorporated into a scene in which they are attached to an anchor point. The screenshots are rotatable around the anchor point and be rendered by a graphics processing unit (GPU).

### BACKGROUND

On a client device, such as a laptop computer, a smartphone, a tablet computing device, or the like, a user may view various files that are stored on the client device or to which the client device has access. Generating rich user interfaces with which files can be viewed or accessed may consume considerable central processing unit (CPU) cycles, which can strain system resources as well as consume battery or power reserve resources of the client device.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example user interface according to various examples of the present disclosure.

FIG. 2 is a drawing of an example user interface according to various examples of the present disclosure.

FIG. 3 is a drawing of an example client device according to various examples of the present disclosure.

FIG. 4 is a drawing of an example user interface according to various examples of the present disclosure.

FIG. 5 is a drawing of an example user interface according to various examples of the present disclosure.

FIG. 6 is a drawing of an example user interface according to various examples of the present disclosure.

FIG. 7 is a flowchart illustrating an example of functionality implemented by the file management application executed by the client device according to various examples.

FIG. 8 is a flowchart illustrating an example of functionality implemented by the file management application executed by the client device according to various examples.

### DETAILED DESCRIPTION

The present disclosure relates to generating a user interface in which a user of a client device 103 may access files that are stored on or accessible to the client device. In the context of this disclosure, such a user interface is referred to as a carousel view, a carousel user interface element, or a carousel user interface. A carousel view, in one example, can provide a user with the ability to view a representation, such as a preview or a screenshot associated with various recently accessed files, as well as launch a file viewer that provides the user with the ability to view, edit, or otherwise work with a particular file that is launched by the user. The representation of the file may include, for example, content of the file, the first page of the file, a series of pages of the file repeating in order, or any other type of representation. The carousel view can be generated by identifying recently accessed files that have been accessed by a user or by a particular application and generating a scene using a graphics application programming interface (API) in a virtual three dimensional space.

In one example, the scene can be created using a graphics API that facilitates rendering of the scene on a display of the client device using a graphics processing unit (GPU). In one embodiment, the graphics API can facilitate rendering of the scene by relying upon processing capability of a GPU of the client device. Relying upon the GPU can also minimize or eliminate reliance upon a central processing unit (CPU) of the client device. The graphics API can also perform calculations related to a physics model associated with the carousel view or other operations that might otherwise consume CPU processor cycles. These CPU processor cycles would, in turn, consume system resources. In this way, by minimizing or avoiding the consumption of CPU processor cycles, the carousel view can provide a particular experience to the user without unnecessarily consuming resources such as a power reserve or battery resources because confining certain operations to the GPU can consume less system resources.

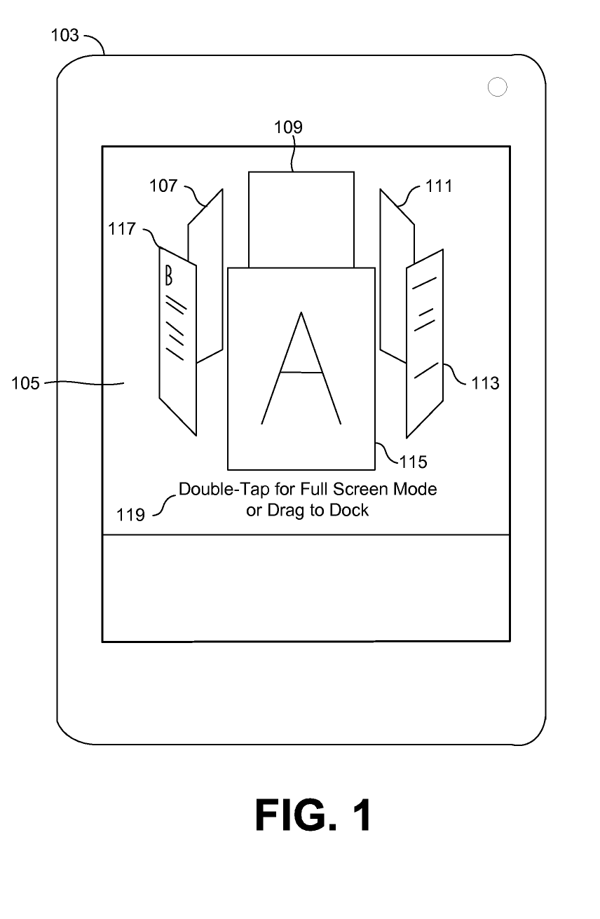

With reference to FIG. 1, shown is one example of a client device 103 according to an embodiment. In the example of FIG. 1, the client device 103 renders a carousel user interface element 105 on a display. In one scenario, an application facilitating the browsing or viewing of files that are accessible to the client device 103 can generate the carousel user interface element 105. The carousel user interface element 105 is generated by capturing a screenshot associated with recently accessed files. For example, the application can capture a representative screenshot associated with recently accessed files and place the screenshots in a three dimensional scene. The three dimensional scene can be rendered using an API that uses a GPU associated with the client device.

In one example, the carousel user interface element 105 can include a scene including screenshots of the six most recently accessed documents. However, it should be appreciated that any number of most recently accessed documents can be incorporated into a carousel user interface element 105 according to various examples. Additionally, although an example of displaying recently accessed files in the carousel is used, any other type of content can also be displayed. For example, a user's favorite files, webpages, contacts, most often used files, webpages, or contacts, most relevant results to a search, recent locations, or any other type of content can be included in a carousel view.

In the example of FIG. 1, the carousel user interface element 105 is generated by capturing screenshots 107, 109, 111, 113, 115, and 117 associated with recently accessed files. An anchor point can be created within a scene using the API. An application in which the scene is created can also attach the screenshots as objects to the anchor point within the scene using the API. In the example shown in FIG. 1, the anchor point can be created at a center point and the screenshots are attached to the anchor point within the scene using the API such that they are rotatable around the anchor point in a particular plane. In the example of FIG. 1, the screenshots are rotatable or “spinnable” around the anchor point in a first plane, such as a horizontal plane, but are not rotatable around the anchor point in another plane, such as a vertical plane. In other words, the screenshot are rotatable around the anchor point in a single plane and not in any other plane. In this way, a carousel effect is achieved in which the screenshots can be rotatable around the anchor point in response to a user input, such as a swipe gesture received via a touchscreen input device.

In another example, the screenshots can be rotatable around the anchor point in a vertical plane but not in a horizontal plane. In another scenario, the screenshots can be rotatable around the anchor point in more than a single plane to create an effect in which the screenshots can be rotated around the anchor point in more than a single direction and axis. Additionally, the carousel user interface element 105 can also respond to other user inputs or gestures, such as a tap, a mouse click, or a selection of one of the depicted screenshots. As indicated by the text 119, the carousel user interface element 105 can allow a user to view a document corresponding to a screenshot in a full screen mode by performing a first gesture. The user interface can also allow the user to view a document corresponding to a screenshot in another portion of the user interface, such as a dock user interface element, by dragging the screenshot to the other portion of the user interface.

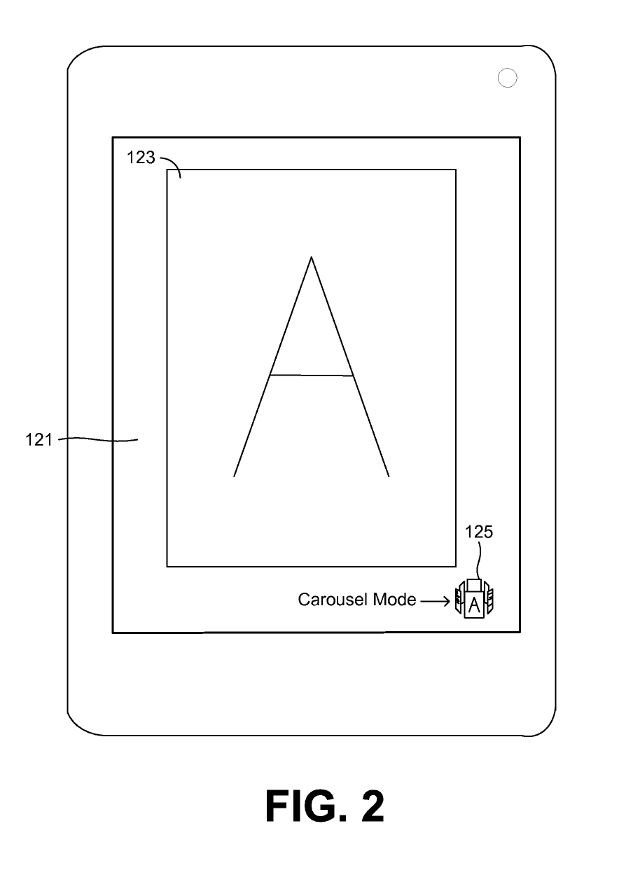

Accordingly, continuing the example of FIG. 1, reference is now made to FIG. 2, which illustrates a full-screen user interface 121 rendered by an application in response to a double tap gesture on the screenshot 115. The screenshot 115 corresponds to a particular document 123 that is accessible by the client device 103. In response to detecting a certain user input or a gesture, such as a double tap gesture, the client device 103 can launch a document viewer or editor in a full screen mode or a mode that provides for a larger view of the document. In a full screen mode, the user can scroll or page through the document 123, edit the document 123, or otherwise interact with the document. Additionally, by following user interface element 125, the user can return to the carousel user interface element 105 in which a carousel user interface element that displays screenshots of recently viewed documents.

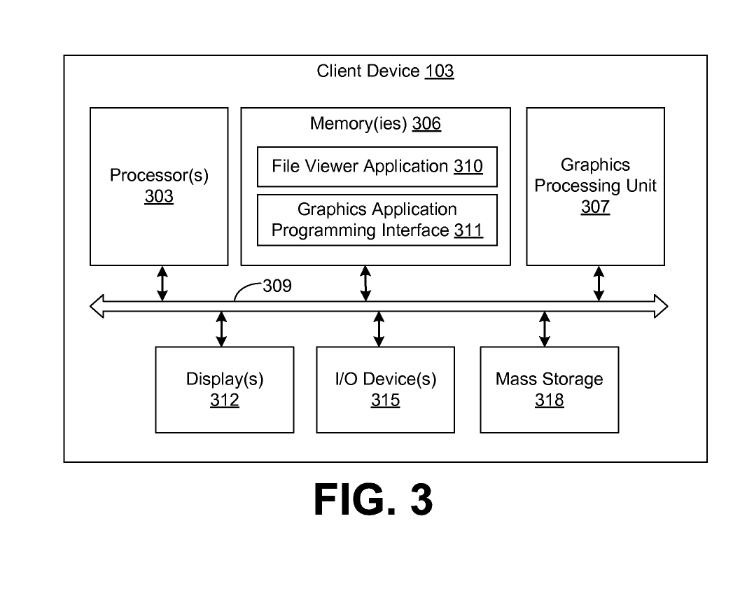

With reference to FIG. 3, shown is a client device 103 in which various embodiments can be implemented. The client device 103 may include, for example, a processor-based system such as a computer system. In this respect, the client device 103 can include at least one processor circuit, for example, having at least one processor 303 and a memory 306, both of which are coupled to a local interface 309, respectively. The processor 303 is also referred to herein as a CPU. The client device 103 can also include a graphics processing unit 307, or a GPU, which is also coupled to a local interface 309. The GPU can include one or more processing cores or processors in which graphics operations or calculations can be performed. Accordingly, an operating system or another software component executed by the client device 103 may include a library or other software module providing a graphics API 311 that facilitates graphics operations. One example of a graphics API 311 that can be employed to generate a carousel user interface element 105 in association with the file viewer application 310 is the SCENEKIT Objective-C framework, OPENGL (the Open Graphics Library), or another API that facilitates interactions with a GPU. The graphics API 311 can also facilitate outsourcing of rendering operations to the GPU rather than relying upon the CPU to render scenes that are displayed by the client device 103.

For example, the graphics API 311 can provide the ability for an application to create a virtual three dimensional scene in which objects can be placed. One or more virtual cameras can also be placed within the scene as well as lighting, coloring, and other aspects of the scene, which can affect how the scene is rendered on the display 312. A physics model can also be associated with a scene using the graphics API 311 that defines how and to what extent objects within the scene move and which stimuli cause movement of objects within the scene. For example, an object can be placed within the scene and various properties associated with the object such that it responds to certain user input. As one scenario, an object can be placed within a scene and be configured to move in response to a touchscreen input obtained from a user upon the object. For example, the object can be configured to respond in different ways to a swipe gesture, a tap gesture, a double tap gesture, or other types of gestures. In another scenario, the object can be configured within the graphics API 311 to spin with a certain angular momentum or angular velocity in response to a swipe gesture received via a touchscreen input device.

Additionally, the GPU 307 can be configured to render a virtual three dimensional scene using substantially its own processing resources without relying upon the processing resources of the processor 303. In some examples, the GPU 307 can render a scene that is created and defined using a graphics API 311 entirely with its own processing resources rather than relying upon the processing resources of the CPU. In such a scenario, relying upon the processing resources of the GPU can result in an efficiently rendered scene with respect to power resources of the client device 103 because the GPU 307 can be optimized to perform calculations necessary to render the scene. The GPU 307 can also be optimized to calculate movement of objects within the scene, perform lighting calculations, shading calculations, coloring calculations, and other operations that are specific to rendering the scene.

A client device 103 may include a mobile device, smartphone, tablet computing device, a personal computing device, or like device. The local interface 309 may include, for example, a data bus with an accompanying address/control bus or other bus structure as can be appreciated. The client device 106 may include a display 312 upon which the GPU 307 can render content as well as one or more input devices 315, such as a mouse, a touch pad, a touchscreen input device integrated into the display 312, or any other input device. The client device 106 can further include mass storage 318, which may include a hard drive, solid state storage, or other storage resources in which files or data can be stored and accessed by applications executed by the client device 103.

The memory 306 can include both volatile and nonvolatile memory and data storage components. Stored in the memory 306 are both data and several components that are executable by the processor 303. In particular, the memory 306 can store a file viewer application 310, graphics API 311, and potentially other applications, libraries, or software modules. The file viewer application 310 can be any application that generates a user interface that facilitates browsing files accessible to or stored on the client device 103. The file viewer application 310 can facilitate browsing files associated with a user account in a file storage service as well as viewing files associated with the user account. To this end, the file viewer application 310 can track the most recently accessed files that are accessed or launched using the file viewer application 310 as well as capture a screenshot associated with the most recently accessed files, which can be used and incorporated within a carousel user interface element 105.

In one example, the file viewer application 310 can capture a screenshot associated with a file accessed by a user and store the screenshot in a random access memory (RAM) of the GPU, the client device 103, or in any other storage or cache accessible to the client device 103. In one example, the screenshot can be stored in the memory of the GPU and not in the memory of the client device 103 to facilitate rendering of the scene by the GPU rather than the CPU. The graphics API 311 can include an interface into a graphics capability associated with the client device 103 by which a three dimensional scene can be created and that can be rendered by the GPU 307. Movement of objects within the scene can also be rendered by the GPU 307. The graphics API 311 can provide the ability to define anchor points to which objects may be attached. The graphics API 311 can also provide the ability to place a virtual camera within a scene, which serves as a vantage point from which a scene can be rendered and displayed upon the display 312. The graphics API 311 can further provide the ability to define various properties about objects placed within the scene. For example, the graphics API 311 can provide the ability to place an anchor point within the scene to which other objects, such as one or more screenshots associated with files, can be attached.

Additionally, the graphics API 311 can provide the ability to define how an object should move within a scene in response to user input, such as gestures captured by a touchscreen input device. For example, the graphics API 311 can provide the ability for an application, such as the file viewer application 310, to include one or more screenshots within a scene that are attached to an anchor point in a radial pattern. Additionally, the file viewer application 310, by leveraging the graphics API 311, can specify that the screenshots are rotatable around the anchor point in response to a swipe gesture captured at certain coordinates or within a region of the display 312. The graphics API 311 can also allow the file viewer application 310 to specify that the screenshots are rotatable in a single plane but not rotatable in another plane, so that a spinning or carousel effect is achieved in response to a swipe gesture.

Next, a description of examples of how the file viewer application 310 or any other application executed by the client device 103 can generate a carousel user interface element 105 according to various examples. To begin, as one example, the file viewer application 310 can identify a set of content, such as a set of recently accessed files that is available to the client device 103. For example, the client device 103 can capture a screenshot associated with a particular file accessed by a user, which can include an image of a first page of a document, a representative page of the document, or any other representation of a document. In the case of a file that is an image or a picture, the screenshot captured by the file viewer application 310 can include a thumbnail of the image. In the case of a file that is a video, the screenshot can include a thumbnail or a screenshot of a particular frame of the video. In some scenarios, the screenshot may include a title screen or another image that is not captured from a frame of the video but that is representative of the video in some way.

The file viewer application 310 can be configured to score a number of screenshots associated with the set of content that corresponds to a number of objects that are in the carousel user interface element 105. The screenshots can be stored in RAM of the GPU or the client device 103, in a dedicated portion of mass storage 318, or in any other cache or storage location. The file viewer application 310 can also discard screenshots that are not incorporated into the carousel user interface element 105. For example, should the carousel user interface element 105 be configured to include screenshots of six most recently accessed files, a screenshot corresponding to the seventh most recently accessed file can be discarded by the file viewer application 310.

To generate the carousel user interface element 105 upon obtaining a request to enter carousel mode, the file viewer application 310 can include a representation of the screenshots associated with the most recently accessed files in a scene generating using the graphics API 311. The screenshots included in the scene as objects are attached to an anchor point in a radial pattern and configured user to rotate about the anchor point in a single plane. The anchor point can be established in a fixed location relative to a virtual camera representing a vantage point from which the scene is rendered. The screenshots can also be configured to rotate or spin around the anchor point in response to a user input, such as a swipe gesture, with an angular velocity that is related to a speed or acceleration associated with the user input. The screenshots can also be configured to have an angular momentum in a physics model associated with the scene in the graphics API 311 such that the screenshots may spin to a certain extent following the user input. In other words, the screenshots may spin around the anchor point for a certain amount of time even after a swipe gesture captured via a touchscreen input device and may progressively slow until stopping. In one example, the carousel can spin at a velocity that is related to a speed of the gesture until stopping at a rate dictated by the physics model specified using the graphics API. In some scenarios, the file viewer application 310 can establish a virtual camera in the scene using the graphics API 311 at a fixed location relative to the anchor point.

The file viewer application 310 can then initiate rendering the scene including the screenshots. The scene can be rendered by the GPU 307 rather than by the CPU by virtue of the fact that the scene was created using the graphics API 311 and GPU 307, which can be configured to cause rendering the scene and perform calculations with respect to the physics model of the scene. In some embodiments, certain operations can be performed by the GPU 307 relying upon the graphics API 311 and other operations can be performed by the CPU. In one scenario, rendering of the scene that incorporates the carousel or spinning element can be rendered by the GPU 307 and not by the CPU, which can potentially minimize load on the processing resources of the client device 103 as well as power resources of the client device 103.

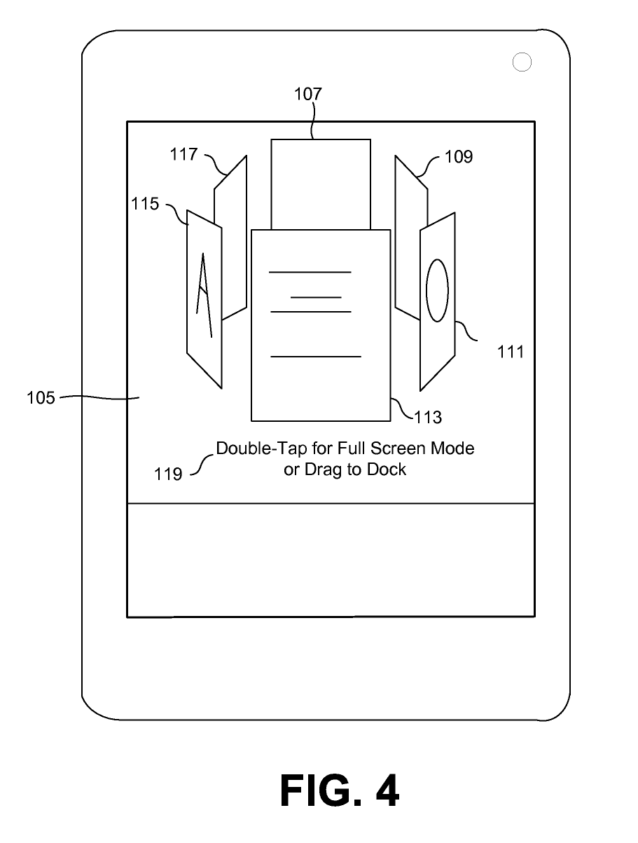

Reference is now made to FIG. 4, which continues the example carousel user interface element 105 that is introduced in FIG. 1. In the depiction shown in FIG. 4, a user has provided a user input, such as a swipe gesture that includes a component in a plane in which the carousel element is rotatable. In response to receiving the swipe gesture, the file viewer application 310 can initiate an update of the scene that can be rendered by the GPU 307 such that the carousel element spins in the direction of the swipe gesture. As shown in FIG. 4, the carousel user interface element 105 has spun in counterclockwise direction around an anchor point positioned in the center of the screenshots. The carousel user interface element 105 has been updated in response to a swipe gesture having a component in the plane in which the screenshots are rotatable. It should be appreciated that the carousel user interface element 105 can spin in a clockwise direction in response to a swipe gesture in an opposite direction as well.

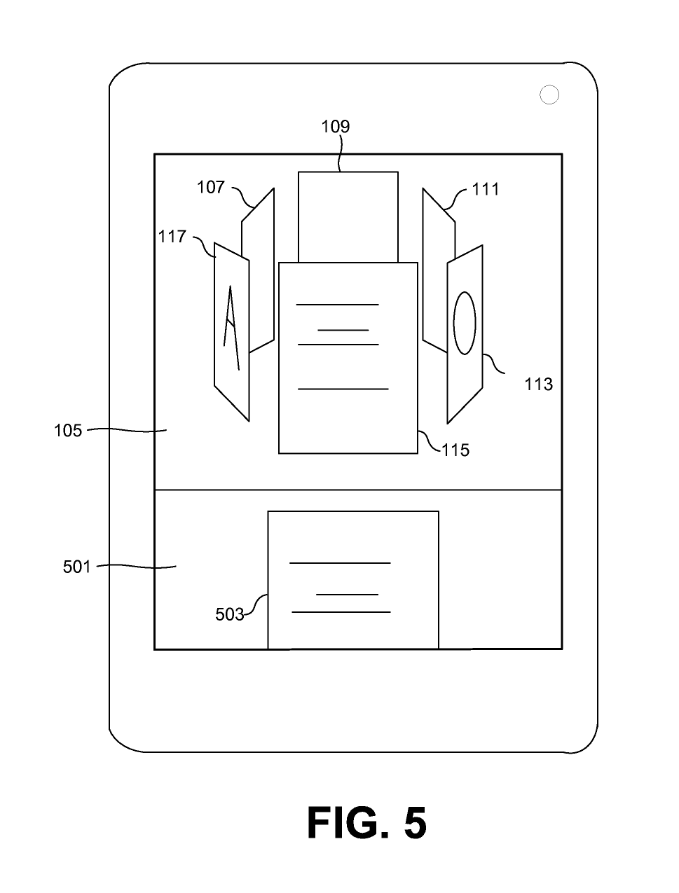

Continuing the example of FIG. 4, reference is now made to FIG. 5, which illustrates an example of the carousel user interface element 105 along with a dock user interface element 501. In the example of FIG. 5, a user has dragged a screenshot corresponding to the document from the carousel user interface element 105 to a dock user interface element 501 positioned in another portion of the user interface. In response to a user dragging a screenshot corresponding to a document to the dock user interface element 501, the file viewer application 310 can cause the document to be opened or launched within the user interface displayed by the client device 103 as denoted by reference numeral 503.

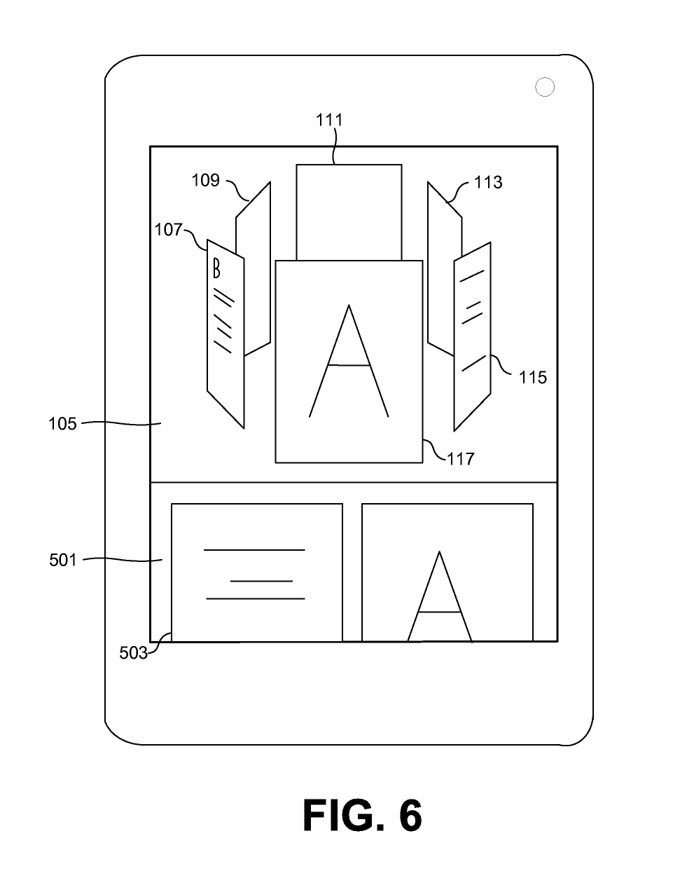

Continuing the example of FIG. 5, reference is now made to FIG. 6. FIG. 6 depicts an example in which a user has rotated the carousel user interface element 105 and dragged another screenshot 117 to the dock user interface element 501. In the depicted example the document corresponding to the screenshot 117 can be opened in a split screen view so the user may view both documents simultaneously on the display 312.

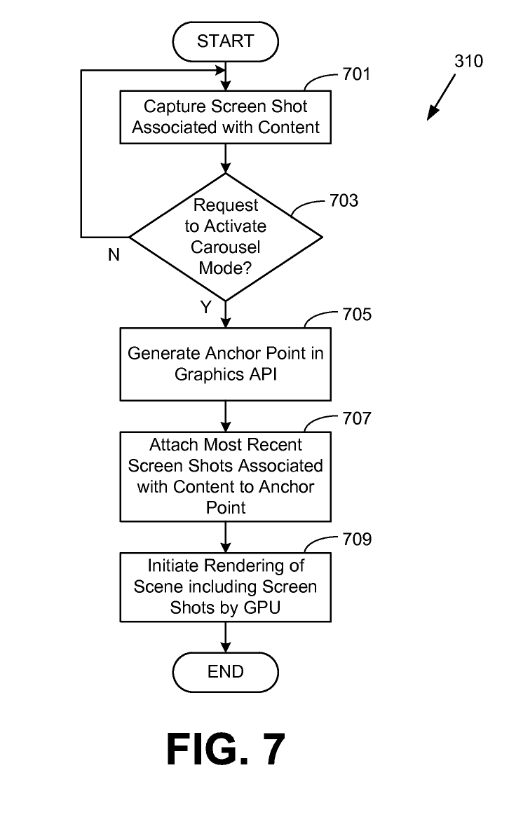

With reference to FIG. 7, shown is a flowchart that provides an example of a portion of the operation of the file viewer application 310 according to various embodiments. In particular, FIG. 7 provides an example of the file viewer application 310 generating a user interface containing a carousel user interface element rendered with a GPU 307 integrated within the client device 103. It is understood that the flowchart of FIG. 7 provides merely an example of the many different types of functional arrangements that may be employed to implement the portion of the operation of the file viewer application 310 as described herein. As an alternative, the flowchart of FIG. 7 may be viewed as depicting an example of elements of a method implemented in the file viewer application 310 according to one or more embodiments.

At element 701, the file viewer application 310 can capture screenshots associated with a set of content. The set of content can include a user's favorite files, recently accessed webpages, bookmarked webpages, recently used contacts, most often used files, webpages, or contacts, most relevant results to a search, recent locations, or any other type of content. The file viewer application 310, in one example, can capture and store a screenshot associated with the most recently accessed N pieces of content, where N is the number of screenshots represented in a carousel user interface element 105 generated by the file viewer application 310 and rendered by the GPU 307. At element 703, if a request to activate a carousel mode is obtained, then at element 705, the file viewer application 310 can generate an anchor point in the graphics API 311. As noted above, the anchor point can be established at a fixed location within a scene that can be rendered by the GPU 307.

At element 707, the file viewer application 310 can attach the screenshots to the anchor point using the graphics API 311. The screenshots can be attached to the anchor point such that they are arranged in a radial pattern around the anchor point. In one example, the screenshots are attached to the anchor point such that when a particular screenshot is located at or near a rear of the anchor point relative to a vantage point from which the scene is rendered, a rear surface of the screenshot is shown, which may include be empty. In other words, a screenshot can be inserted into the scene such that it has a front surface that represents the screenshot and a rear surface that does not. Next, at element 709, the file viewer application 310 initiates rendering the scene by the GPU 307. Thereafter, the process can proceed to completion.

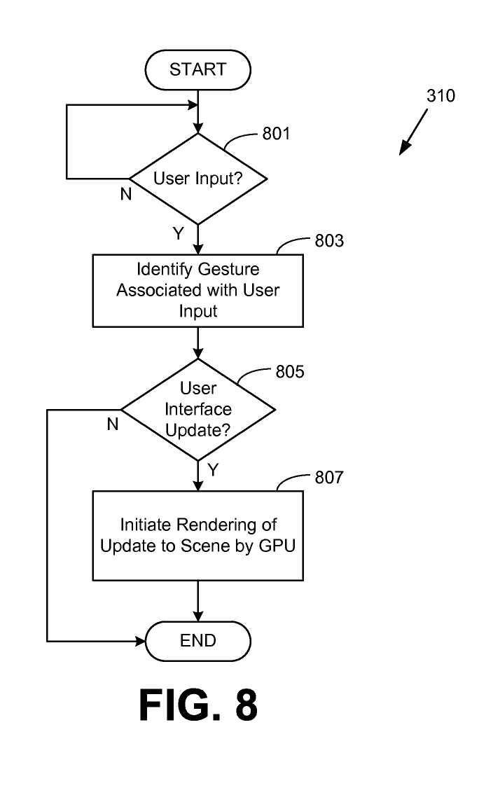

With reference to FIG. 8, shown is a flowchart that provides an example of a portion of the operation of the file viewer application 310 according to various embodiments. In particular, FIG. 8 provides an example of the file viewer application 310 updating a user interface containing a carousel user interface element rendered with a GPU 307 integrated within the client device 103. It is understood that the flowchart of FIG. 8 provides merely an example of the many different types of functional arrangements that may be employed to implement the portion of the operation of the file viewer application.

At element 801, the file viewer application 310 can determine whether a user input is obtained via the client device 103. A user input can include a gesture performed by the user on a touchscreen input device. A user input may also include selection of an item rendered upon the display 312 of the client device 103 as well as a particular gesture provided as an input to select the item. If a user input is obtained at element 801, the process proceeds to element 803. Otherwise, the file viewer application 310 can remain at element 801 listening for user inputs.

At element 803, the file viewer application 310 can identify a particular gesture associated with a detected input. At element 805, the file viewer application 310 can determine whether the gesture necessitates an update to a carousel user interface element. For example, in the case of a swipe gesture, the file viewer application 310 can determine whether the gesture includes a component in the plane or axis in which the screenshots in the carousel user interface element are rotatable around the anchor point. In the case of a tap gesture or a double tap gesture, the file viewer application 310 can determine whether the gesture coordinates overlay a particular screenshot in the carousel user interface element that would necessitate activating a full screen mode in which the document can be viewed. If the file viewer application 310 determines that the carousel user interface element should be updated, then the file viewer application 310 initiates rendering of the carousel user interface element at element 807. Thereafter, the process proceeds to completion.

The flowcharts of FIGS. 7-8 show examples of the functionality and operation of implementations of components described herein. The components described herein can be embodied in hardware, software, or a combination of hardware and software. If embodied in software, each element may represent a module of code or a portion of code that includes program instructions to implement the specified logical function(s). The program instructions may be embodied in the form of, for example, source code that includes human-readable statements written in a programming language and/or machine code that includes machine instructions recognizable by a suitable execution system, such as a processor in a computer system or other system. If embodied in hardware, each element may represent a circuit or a number of interconnected circuits that implement the specified logical function(s).

Although the flowcharts show a specific order of execution, it is understood that the order of execution may differ from that which is shown. For example, the order of execution of two or more elements may be switched relative to the order shown. Also, two or more elements shown in succession may be executed concurrently or with partial concurrence. Further, in some embodiments, one or more of the elements shown in the flowcharts may be skipped or omitted.

Also, one or more or more of the components described herein that comprise software or program instructions can be embodied in any non-transitory computer-readable medium for use by or in connection with an instruction execution system such as, for example, a processor in a computer system or other system. Such a computer-readable medium may contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein may be implemented and structured in a variety of ways. For example, one or more components described may be implemented as modules or components of a single application. Further, one or more components described herein may be executed in one computing device or by using multiple computing devices.

It is emphasized that the above-described embodiments of the present disclosure are merely examples of implementations to set forth for a clear understanding of the principles of the disclosure. Many variations and modifications may be made to the above-described embodiments without departing substantially from the spirit and principles of the disclosure. All such modifications and variations are intended to be included herein within the scope of this disclosure.

Therefore, the following is claimed:

1. A method, comprising:
capturing, by a client device, at least one representation of content on the client device;
obtaining, by the client device, a request to activate a carousel mode associated with the content;
generating, by the client device, an anchor point using an application programming interface (API);
attaching, using the API, the at least one representation to the anchor point, wherein the at least one representation is rotatable around the anchor point in response to a user input; and
rendering, using the API, the at least one representation on a display, wherein a movement of the at least one representation around the anchor point is rendered by a graphics processing unit (GPU).

2. The method of claim 1, wherein the movement of the at least one representation around the anchor point is rendered by the GPU and not by a central processing unit.

3. The method of claim 1, wherein the at least one representation is stored in a random access memory (RAM) associated with the client device.

4. The method of claim 1, wherein the API facilitates creating of a scene and rendering frames of the scene in the GPU.

5. The method of claim 1, wherein the at least one representation is configured to be rotatable about a single plane around the anchor point.

6. The method of claim 1, further comprising positioning a viewpoint using the API at a fixed location facing the anchor point, wherein the at least one representation is rendered on the display rotating about the anchor point in response to a user gesture.

7. The method of claim 6, wherein the user gesture comprises a swipe gesture captured by a touchscreen input device.

8. The method of claim 1, wherein the content includes at least one document, the method further comprising:
adding, by the client device, a document to a dock in response to dragging the document to the dock;
rendering, by the client device, the document in another portion of a user interface in response to the document being added to the dock.

9. The method of claim 8, further comprising:
adding, by the client device, a second document to the dock in response to dragging the second document to the dock;
rendering, by the client device, the document and the second document in the other portion of a user interface in response to the second document being added to the dock.

10. A non-transitory computer-readable medium embodying a program executable in a client device, the program, when executed by the client device, being configured to cause the client device to at least:
identify content accessed by the client device;
capture a screenshot associated with the content;
obtain a request to activate a carousel mode associated with an application facilitating viewing of the content;
generate an anchor point in a three dimensional scene facilitated by an application programming interface (API);
attach, using the API, the screenshot to the anchor point, wherein the screenshot is rotatable around the anchor point in response to a user input and a plurality of previous screenshots are attached to the anchor point and rotatable around the anchor point; and
render, using the API, the screenshot and at least a portion of the plurality of previous screenshots on a display associated with the client device using a graphics processing unit (GPU) associated with the client device.

11. The non-transitory computer-readable medium of claim 10, wherein the screenshot and the plurality of previous screenshots rotate around the anchor point in a first plane.

12. The non-transitory computer-readable medium of claim 10, wherein the content comprises at least one of: a plurality of recently accessed files, a plurality of recently accessed webpages, a plurality of recent locations, or a set of search results.

13. The non-transitory computer-readable medium of claim 11, wherein the user input comprises a swipe gesture obtained using a touchscreen input device.

14. The non-transitory computer-readable medium of claim 10, wherein the plurality of previous screenshots comprise a predetermined number of most recently accessed files.

15. The non-transitory computer-readable medium of claim 10, wherein the content comprises a document and the screenshot comprises a first page of a document.

16. The non-transitory computer-readable medium of claim 10, wherein the screenshot comprises a thumbnail image associated with the content.

17. A computing device, comprising:
a central processing unit (CPU);
a graphics processing unit (GPU);
a display; and
an application executable by the CPU, wherein the application is configured to cause the CPU to at least:
capture a plurality of screenshots associated with content accessible on a client device;
generate an anchor point in a three dimensional scene using a graphics application programming interface (API), the three dimensional scene rendered on the display by the GPU;
associate, using the API, the plurality of screenshots with the anchor point, wherein the plurality of screenshots are rotatable around the anchor point in response to a user input; and
update, by the GPU, the three dimensional scene on the display in response to a user input, wherein movement of the plurality of screenshots around the anchor point is rendered by the GPU.

18. The computing device of claim 17, wherein the plurality of screenshots are stored in a memory of the GPU, wherein the memory of the GPU is separate from a memory of the computing device.

19. The computing device of claim 17, wherein the plurality of screenshots are attached to the anchor point in the three dimensional scene in a radial pattern.

20. The computing device of claim 17, wherein the plurality of screenshots are associated with an angular momentum in a physics model associated with the three dimensional scene.
